(19) United States
(12) Patent Application Publication
(10) Pub. No.: US 2002/0106141 A1
(43) Pub. Date: Aug. 8, 2002

(54) Low-loss electrode designs for high-speed optical modulators

(75) Inventor: Ganesh K. Gopalakrishnan, Bethesda, MD (US)

Correspondence Address: MORGAN LEWIS & BOCKIUS LLP, 1111 PENNSYLVANIA AVENUE NW, WASHINGTON, DC, 20004, US

(73) Assignee: Codeon Corporation

(21) Appl. No.: 09/778,841

(22) Filed: Feb. 8, 2001

(51) Int. Cl. G02F 1/035

(52) U.S. Cl. 385/2

(57) ABSTRACT

An optical modulator device that substantially prevents coupling of a desired coplanar waveguide (CPW) electromagnetic wave mode with other spurious modes within non-active sections the modulator structure without significantly impacting the modulation efficiency in an active section of the device. The modulator includes an electrooptic substrate and a buffer layer that is formed on a surface of the electrooptic substrate. The buffer layer includes a thin portion that occupies an active section of the electrooptic substrate where modulation occurs, and a thicker portion that overlies the electrooptic substrate in one or more non-active sections of the device. The thinner portion of the buffer layer allows significant electrical-optical overlap of the CPW electromagnetic wave with an optical wave propagating within a waveguide formed in the active section of the device substrate. One or more thicker buffer layer portions on one or more non-active sections of the electrooptic substrate substantially prevent penetration of the CPW electromagnetic field into the electrooptic substrate in the non-active sections, and thus restrict coupling with undesirable modes the electrooptic substrate can support.

### BACKGROUND OF THE INVENTION

1. Field of the Invention

The present invention relates to optical modulators that are of interest to communication systems, and more particularly, to electrode arrangements for high-speed optical modulators.

2. Discussion of the Related Art

As the demand for high-speed and complex optical communication systems continues to grow, so too has the need for reliable high-speed devices needed for modulating optical signals traversing such systems. Optical modulators are of great interest in operating a fiber optic communication system in the range of 2.5 to 10 Gbps (Giga bits per second), and potentially 10-40 Gbps or more. Of particular interest are modulators having low operating voltage and low optical and/or electrical losses that can reliably modulate optical signals transmitted through optical fiber or other optical media.

Optical modulators use anisotropic materials of uniaxial crystal whose permittivities are directly proportional to an applied electric field and vary almost linearly with an applied electric field. This electrooptic property is known as the Pockels effect. Applying an electric field across an area occupied by a light signal in these types of uniaxial materials can modulate the light signal utilizing the electrooptic properties of the material. Because wave velocity is generally inversely proportional to the square root of the permittivity of the material in which the wave is propagating, a change in permittivity affects wave velocity within the electric field. In uniaxial crystal waveguides, this effect is advantageously used to shift a phase of the carrier wave traveling through the crystal and thus modulate the carrier wave phase.

Of uniaxial materials used to fabricate optical modulators, lithium niobate (LiNbO₃) or lithium tantalate (LiTaO₃) are popular substrate choices. LiNbO₃ is widely used due to its combination of low loss characteristics, high electrooptic coefficients, and high optical transparency in the near infrared wavelengths used for telecommunications. Its high Curie temperature (1100° C.-1180° C.) makes it practical for fabrication of optical waveguides because strip waveguides can be fabricated by means of Ti-indiffusion at temperatures near 1000° C.

LiNbO₃ wafers are available in three different crystal cuts (x-, y-, and z-cut). For the most pronounced electrooptic effect, the strongest component of the applied electric field is aligned with the z-axis of the crystal (because the z-axis has the highest electrooptic coefficient) to take advantage of the r₃₃ coefficient. On z-cut LiNbO₃, vertical fields are used with a TM mode to take advantage of the r₃₃ coefficient. On x-cut, horizontal field electrodes and a TE mode utilize the r₃₃ coefficient.

Optical modulators with performance in the 40 GHz frequency range and beyond are important components in optical communication systems. Recently, various groups have demonstrated several such modulators using LiNbO₃ substrates. One type of optical modulator, used extensively, for example, in applications ranging from long-haul fiber-optic communication systems to microwave instrumentation, is a traveling-wave (TW) modulator. To achieve broad band modulation in the DC −40 GHz range, LiNbO₃ TW modulators must be designed so that the optical wave and the RF modulation signal propagate with equal phase velocities through the LiNbO₃ modulating medium, allowing the modulating fields to act on the optical wave over a long path, regardless of how rapidly the modulating fields are changing.

To achieve high-frequency modulation in a LiNbO₃ TW optical modulator, the electrical and optical velocities of the modulating and modulated signals must be matched. This may be achieved by employing thick coplanar waveguide (CPW) electrodes in conjunction with an intervening buffer layer. Thick CPW electrodes generally have low RF loss and provide enhanced velocity matching due to the presence of electric flux in the air gaps between them. Buffer layers, typically formed of silicon dioxide (SiO₂), are required in high-frequency modulators for broadband velocity matching on both x- and z-cut devices due to the high RF dielectric constants of LiNbO₃ relative to the optical dielectric constants. Partial propagation of the microwave mode in the lower dielectric constant media of the buffer layer provides for speeding up the microwave mode to obtain velocity match with the optical mode within waveguide arms.

FIGS. 1a and 1b are top and cross-sectional views of a conventional TW optical modulator 10 utilizing thick CPW electrodes and a buffer layer for velocity matching. As shown in FIG. 1a, TW modulator 10 includes a CPW including two ground electrodes 22, 24, and an RF feed line electrode 26 formed over a LiNbO₃ substrate 12 (shown in cut-away) with an intervening SiO₂ buffer layer 25. Electrodes 22, 24 and 26 overlie a single mode channel waveguide Mach-Zehnder Interferometer (MZI) 14 formed in a LiNbO₃ substrate 12. With reference to FIG. 1b, the MZI 14 is patterned in LiNbO₃ substrate 12 using a titanium (Ti) diffusion or annealed proton exchange processes. Buffer layer 25 is formed on surface 12a of the LiNbO₃ substrate 12 by conventional processes, such as CVD or sputtering, for example. To provide enhanced velocity matching between the microwave and optical modes, electrodes 22, 24, and 26 are formed to have a thickness in excess of 10 μm, for example. In z-cut LiNbO₃, electrode 22 (or 24) is formed over one MZI arm 14a and electrode 26 is formed over the other MZI arm 14b. If an x-cut LiNbO₃ substrate is used, each MZI arm would be arranged between a ground electrode and the RF feed line. Electrodes 22 and 24 are supplied with a ground potential, while electrode 26 is supplied with an RF signal and terminates at impedance R_{T}.

As shown in FIG. 1a, the layout of the TW optical modulator includes an active section 100, a bend section 110, a taper section 120, and an input/output section 130. Non-active sections 110-130 are designed in conjunction with the active section 100 to allow for external electrical and optical access to the modulator. Microwave input to the device is applied at the input/output section 130 whose dimensions match those of a connector, such as a coaxial microwave K-connector. The tapers provide both dimensional and impedance matches between the input/output section 130 and the active section 100 of the modulator. Bend sections 110 are provided to locate optical and electrical access ports along different edges of the LiNbO₃ substrate 12.

In operation, when a carrier wave from a light source, for example a DFB laser, enters at optical waveguide input port 16, the carrier power is evenly split at the first Y junction of the MZI into the two channels of the MZI arms 14a and 14b. By applying an electric field between the RF electrode 26 and ground electrodes 22 and 24, oppositely oriented electric field vectors exist in the crystal, one in each MZI arm 14a and 14b. Consequently, the carrier light wave within each of the arms is complementarily phase shifted relative to one another in push-pull fashion. Light from each arm is then combined at the second Y junction where constructive or destructive interference resulting from combining phase shifted carrier waves causes signal intensity modulation. When the total phase shift θ between the carrier waves in arms 14a and 14b is such that θ=π, light radiating into the substrate at input port 16 leaves at output port 18 with zero channel output. Thus, optical modulators utilizing electrooptic substrates in this fashion may be used to switch and/or modulate an optical carrier signal propagating in an optical waveguide formed in the substrate.

However, because of LiNbO₃ has dielectric constants ε_{extraordinary}≈28 and ε_{ordinary}≈44, planar and uniplanar transmission lines, such as microstrip and CPW/CPS, tend to be very dispersive when formed on LiNbO₃. As an applied modulating signal frequency increases, electric fields become more concentrated below metal strips of the waveguide where the LiNbO₃ substrate permittivity has already resulted in a relatively larger electric displacement. Since the fields are forced into the dielectric substrate to an increasing extent as the frequency increases, a frequency dependent effective permittivity can be defined for the transmission line.

Once the fields penetrate into LiNbO₃ substrate, several effects often occur. First, depending on the frequency, the microstrip or CPW/CPS mode often couple with other slower modes supported by the substrate. These other modes could either be highly dispersive slab modes, such as TE and TM grounded slab modes, or less dispersive zero-cutoff quasi-TEM modes. When coupling to other modes occurs, there is a loss of power in the intended mode. The amount of power loss to these other extraneous modes depends on the field overlap between the guided mode and the other spurious modes.

One approach to avoid coupling to higher order spurious modes in CPW structures is to reduce the cross-sectional dimensions of the CPW transmission line. See M. Riaziat et al., “Propagation Modes and Dispersion Characteristics of Coplanar Waveguides,” IEEE Trans. Microwave Theory and Techniques, Vol. 38, No. 3, March 1990, pp. 245-251, incorporated herein by reference. With reference to FIG. 2, decreasing the sum of the CPW slot widths W and the center strip S, i.e., decreasing (S+2W), causes less field penetration into the dielectric substrate 28. Hence, overlap between the guided CPW mode and other spurious modes is decreased. Since there is less overlap between the guided mode and other spurious modes in structures with smaller (S+2W), there is less loss of power in the guided mode.

In the context of optical modulators, dispersion in the active section of the modulator can seriously hamper its high-speed operation. This is because over the frequency range of interest, if the electrical velocity varies and induces electrical-optical walk-off, the modulator response is degraded. Fortunately, in LiNbO₃, dispersion in the modulator's active section is generally not a significant problem because the dimensions of the CPW electrode are fairly narrow (e.g., S+2W is typically between approximately 38-60 μm), and hence the fields are fairly well confined to the slots over the frequency range of interest. Also, the relatively lower dielectric constant of a buffer, such as SiO₂ (εᵣ=3.84), carries a good portion of the field and thus restricts field penetration into the LiNbO₃ substrate to a narrow region in the vicinity of the waveguide.

However, non-active sections of the modulator, such as sections 120 and 130 of FIG. 1a, are flared to facilitate connection of the device via standard electrical connectors (SMA, K, V, and the like). In non-active sections of the modulator there is significant field penetration into the LiNbO₃ substrate due to the relatively wider dimensions of the slots in the non-active section compared to slots in the active section, as shown in FIG. 1b by flux groups 50 and 51. This introduces significant dispersion in the modulator's non-active electrode sections, and also increases the opportunity for spurious mode coupling into the slower substrate modes or any other zero-cutoff modes that the structure can support.

Accordingly, in an optical modulator it would be desirable to have substantial field penetration into the modulator's electrooptic substrate from the point of view of facilitating substantial optical-electrical overlap in the modulator's active region. However, from a high-frequency-electrode-loss point of view, it also would be desirable to restrict electric field penetration only to active sections of the modulator where the optical waveguides are to avoid dispersion and/or losses due to spurious mode coupling.

Thus, there remains a need in the art for high-frequency optical modulation devices capable of providing substantial electrical-optical overlap in the modulator's active section while avoiding spurious mode coupling in non-active sections to alleviate the aforementioned problems associated with present optical modulator devices.

### SUMMARY OF THE INVENTION

Accordingly, the present invention is directed to an optical modulator device that substantially obviates one or more of the problems due to limitations and disadvantages of the related art.

The present invention has been made in view of the above circumstances and provides a buffer layer on an electrooptic substrate of an optical modulator that substantially restricts electric field penetration in the substrate to the active region of the modulator.

One aspect of the present invention relates to a buffer provided on an optical modulator electrooptic substrate that is thicker in non-active regions of the optical modulator than in an active region of the modulator.

Another aspect of the present invention relates to an optical modulator having a buffer layer provided between CPW electrodes and an electrooptic substrate such that the buffer carries a significant amount of the electric field provided by the CPW electrodes to substantially prevent electric field penetration into LiNbO₃ in the non-active substrate regions, while allowing sufficient optical-electrical overlap in the active section of the device.

Still another aspect of the present invention relates to an optical modulator that substantially prevents power losses of a guided wave of the modulator by avoiding coupling of the guided wave with spurious modes supported by the modulator's electrooptic substrate material.

Additional aspects of the invention will be set forth in part in the description that follows, and in part will be obvious from the description, or may be learned by practice of the invention. The aspects of the invention will be realized and attained by means of the elements and combinations particularly pointed out in the appended claims.

It is to be understood that both the foregoing general description and the following detailed description are exemplary and are intended to provide further explanation of the invention, as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description, serve to explain the principles of the invention.

In the drawings:

FIG. 1a depicts a top view of a conventional optical modulator utilizing a Mach-Zehnder Interferometer.

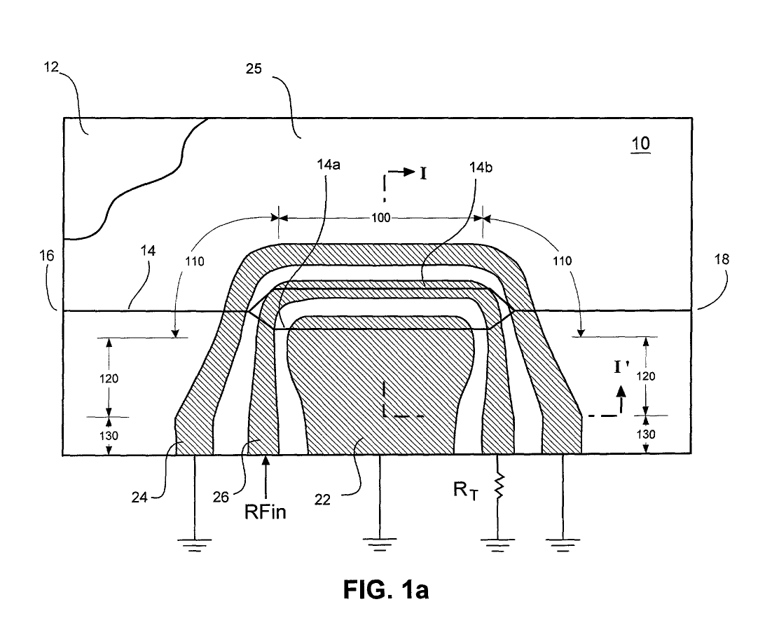

FIG. 1b is a cross-sectional view of the device of FIG. 1a taken along I-I′.

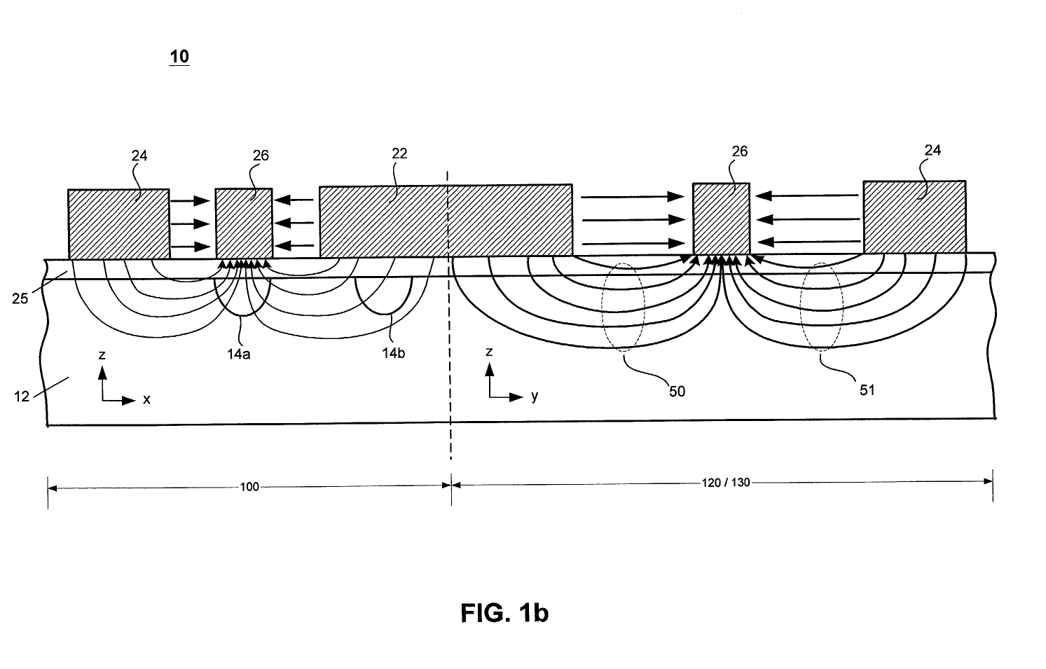

FIG. 2 illustrates a cross-sectional view of a coplanar waveguide (CPW) formed on a dielectric substrate.

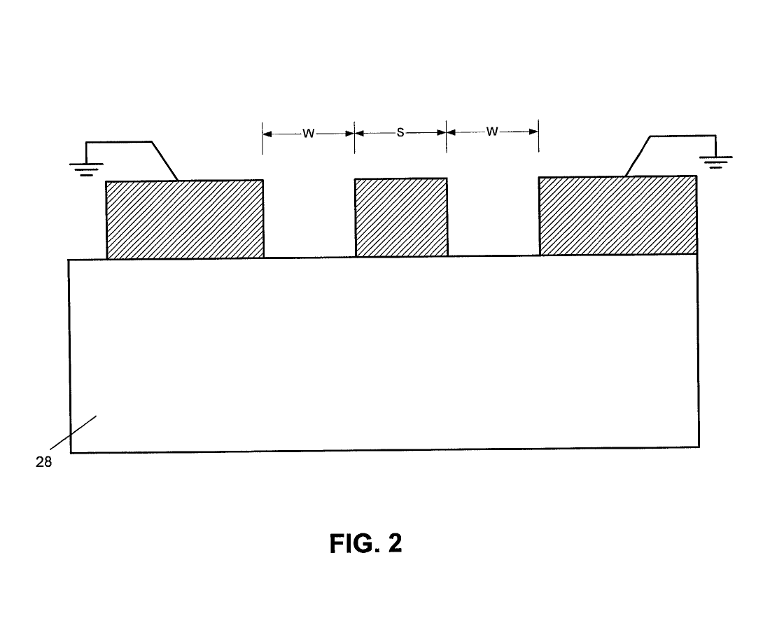

FIG. 3a is a top view of a first exemplary embodiment of an optical modulator according to the present invention.

FIG. 3b is a cross-section view of the device of FIG. 3a taken along II-II′.

FIG. 3c is a cross-section of the device of FIG. 3a taken along III-III′

FIG. 4a is a top view of a second exemplary embodiment of an optical modulator according to the present invention.

FIG. 4b is a cross-section view of the device of FIG. 4a taken along IV-IV′.

FIG. 5a is a top view of a third exemplary embodiment of an optical modulator according to the present invention.

FIG. 5b is a cross-section view of the device of FIG. 5a taken along V-V′.

### DETAILED DESCRIPTION OF THE PREFERRED EMBODIMENTS

As described above, the SiO₂ buffer layer has a significantly lower dielectric constant than LiNbO₃, and thus a significantly lower index, and carries a significant portion of the field, especially in the active section of the modulator. Increasing the buffer layer thickness even further would cause a larger field drop across the buffer layer, and thus allow for less field penetration into non-active sections of the modulator. However, if this approach were taken in the active sections of the modulator, there would be a loss of modulation efficiency due to a decrease in overlap between the optical and electrical fields because of the partial voltage drop across the buffer layer.

The inventor has discovered that a buffer layer formed with an increased thickness in the non-active sections of an optical modulator compared with a buffer layer thickness in the active section of the modulator does not impact the electrical-optical field overlap in the device active section. The thicker portion of the buffer layer substantially prevents a CPW supplied electric field from encroaching into the device electrooptic substrate in non-active device sections, while the thinner buffer layer portion allows good electrical-optical overlap within the electrooptic substrate in the active section of the device. So forming a buffer layer within an optical modulator provides high-speed optical modulation having minimal dispersion and/or low power loss that are associated with undesirable mode coupling in device non-active regions.

Reference will now be made in detail to the present exemplary embodiments of the invention illustrated in the accompanying drawings. Whenever possible, the same reference numbers will be used throughout the drawings to refer to the same or like parts.

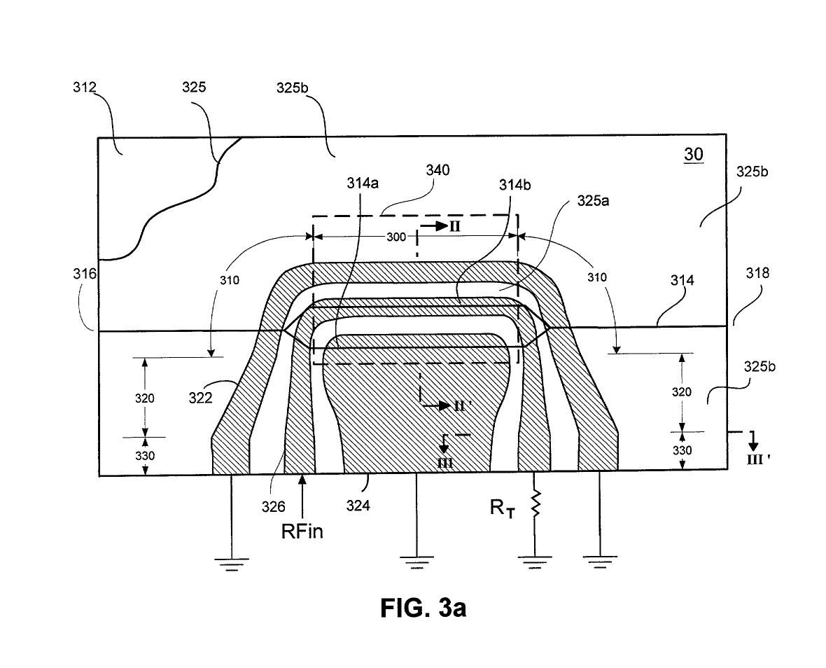

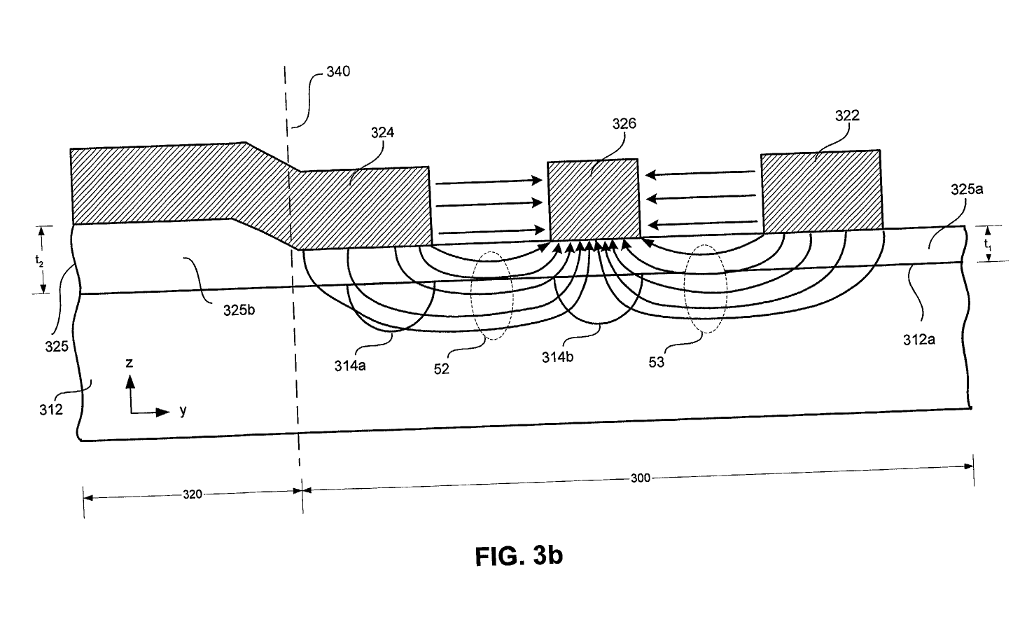

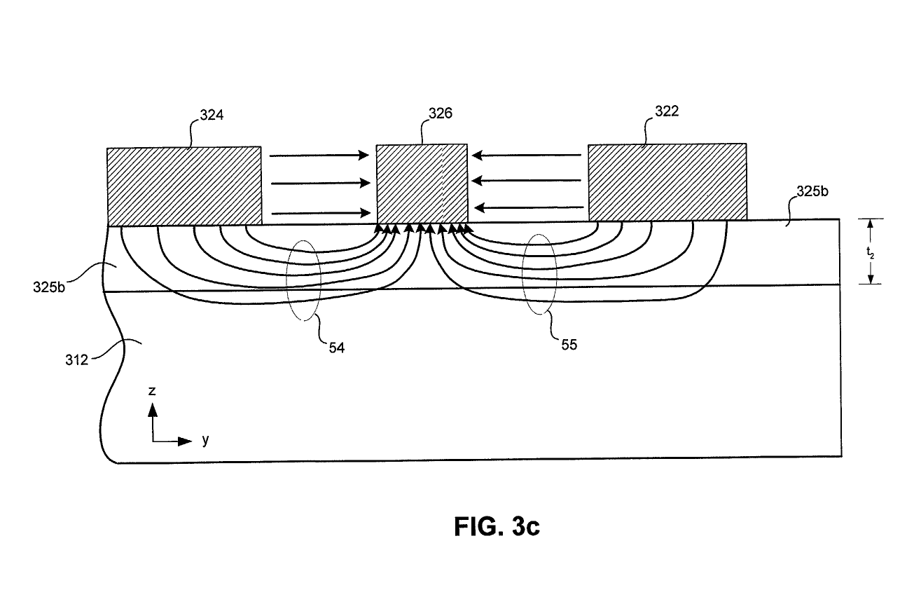

FIG. 3a shows an exemplary optical modulator 30 in accordance with a first embodiment of the present invention. An MZI waveguide 314 is formed in an electrooptic substrate 312, such as z-cut LiNbO₃, by diffusing Ti into the LiNbO₃ surface or, alternatively, by using an annealed proton exchange process. A buffer layer 325 having a lower dielectric constant than electrooptic substrate 312, such as SiO₂, is deposited on the substrate surface. Buffer layer 325 includes a first portion 325a formed in an active region 300 that lies within the region delineated by dotted line 340, and a second, thicker portion 325b formed in the non-active modulator sections that include bend sections 310, taper sections 320 and input/output sections 330. A CPW is formed on the buffer layer 325 by defining ground electrodes 322, 324 and an RF electrode 326. Ground electrode 324 and RF electrode 326 respectively overlie MZI arms 314a and 314b.

The exemplary configuration shown in FIGS. 3a to 3c pertains to a z-cut LiNbO₃ crystal. It is to be understood that the present invention may be practiced with other electrooptic materials, such as LiTaO₃, or other LiNbO₃ crystals, such as an x-cut LiNbO₃ crystal. In an x-cut substrate, the waveguide arms would be located between the RF electrode 326 and ground plane electrode 322, 324 to maintain electric field lines substantially along the z-axis of the LiNbO₃ crystal.

In operation, a coherent light source (not shown), such as a DFB laser at 1.3 or 1.55 μm, is coupled to an input port 316 of waveguide 314. The wave propagates in the waveguide until it reaches a first Y coupler of the MZI where it splits and propagates along arms 314a and 314b. While the wave traverses the MZI arms, it may be modulated by an electric field supplied by the CPW electrode arrangement 322-326. Thereafter, the wave from MZI arms 314a and 314b recombines at a second Y coupler of the MZI and is output via output port 318 for transmission over an optical fiber link (not shown).

FIGS. 3b and 3c illustrate buffer layer 325 in cross-sections along active and non-active sections of the device shown in FIG. 3a. With reference to FIG. 3b, a first portion 325a of buffer layer 325 having a first thickness t₁ is formed on the LiNbO₃ surface 312a within the device active section 300. In bend section 310 (not shown), taper sections 320 and input/output sections 330, a second portion 325b of buffer layer 325 is formed with a second thickness t₂ that is greater than t₁. For example, t₁ may be approximately 1 μm thick and t₂ may be approximately 2 μm thick. As shown in FIG. 3b, ground electrode 324 overlies buffer layer portion 325b in non-active modulator sections 320 and 330. Near the active section 300, buffer layer 325 tapers to form a thinner buffer layer portion 325a that underlies electrodes 322, 326 and a peripheral portion of electrode 324. A tapered profile between the active and non-active device sections may be achieved in a variety of ways known to those skilled in the art. For example, an SiO₂ layer first may be deposited in a CVD process to a thickness t₂ and the portion overlying the active region may be etched back while masking the buffer layer portion over the non-active modulator sections.

While region 340 is shown as only including active section 300, it is to be understood that buffer layer 325 may be thinned over a combination of sections that include the active section with any one or combination of non-active sections. For example, active section 300 and bend section 310 may be included within region 340.

As conceptually shown in FIG. 3b, electric field lines 52 and 53 are substantially confined to an area in the vicinity of waveguide arms 314a and 314b, and thus good electrical-optical field overlap exists within active region 300. On the other hand, FIG. 3c shows a crosssection of a non-active portion of the modulator that is taken along C-C′ at the boundary between a taper section 320 and an input/output section 330. As shown in FIG. 3c, since electrode geometries are wider in non-active regions than they are in the active region, there will always be field penetration into the underlying LiNbO₃ substrate. However, the dielectric buffer in the non-active section is substantially thicker than in the active region. The lower dielectric constant buffer layer material 325b substantially carries electric field lines 54 and 55 to limit the extent of field penetration into the LiNbO₃ substrate. Since electric field penetration into the substrate is limited, overlap of the field with other substrate spurious modes is reduced compared with a modulator having a thin uniform buffer layer.

In addition to providing a thicker buffer layer in non-active sections of a modulator device, the cross-sectional area (S+2W) of the CPW in the non-active sections may also be made small, for example, from 300 to 1000 microns, to minimize attenuation due to radiated waves into the substrate from the CPW.

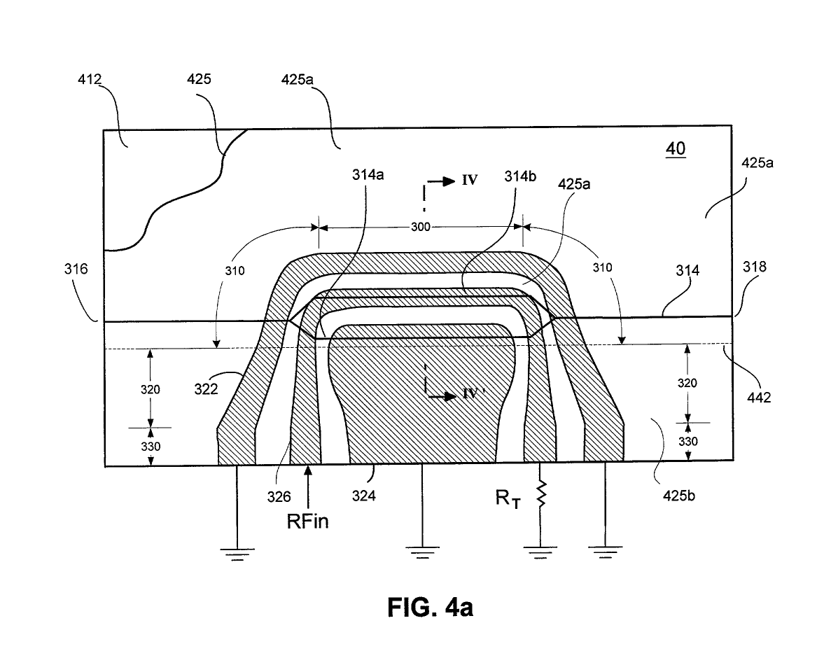

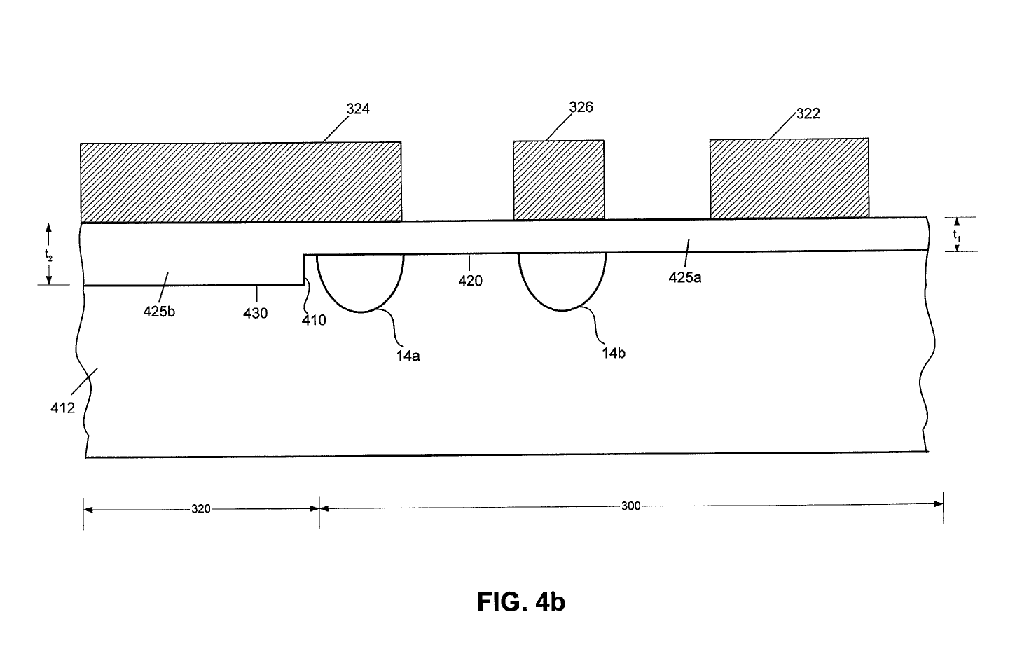

While the embodiment above uses a tapered buffer layer structure, transitional area(s) between thin and thick portions of the buffer layer of present invention may take on other forms, as exemplified below. FIGS. 4a and 4b respectively show top and cross-sectional views of an optical modulator device 40 in accordance with a second exemplary embodiment of the present invention. Optical modulator device 40 utilizes a step structure in a ridged LiNbO₃ substrate 412 to provide a transition between thicker and thinner portions of buffer layer 425. In FIGS. 4a and 4b, elements with the same numbers as in FIG. 3a and 3b are described above. In FIG. 4a, dotted line 442 delineates a region including active section 300 and bend sections 310 the where the buffer layer 425 is thinned. Below the active section 300 and bend sections 310, a step is formed in LiNbO₃ substrate 412 to form a ridged substrate structure.

FIG. 4b is a cross-section of device 400 taken along IV-IV′ of FIG. 4a. As shown in FIG. 4b, the LiNbO₃ substrate 412 has a step 410 between the taper sections 320 and the bend and active sections 310 and 300. Buffer layer 425a is formed thinner on the upper portion 420 of the substrate, while the thicker buffer layer portion 425b is formed on the substrate ridge 430. In the ridge structure of FIG. 4b, the SiO₂ buffer layer may first be deposited on the entire substrate until a thickness on the lower ridge section exceeds the height of the step by at least the desired thickness of the buffer portion 425a. Thereafter, the portion of the buffer overlying the elevated portion of the substrate is etched back or planarized using a CMP process, or other planarization techniques known to those skilled in the art, to the level of the buffer layer over of the lower substrate portion. The resultant upper surface of buffer layer 425 can be made substantially planar to improve the integrity of CPW metallization.

Instead of a taper or a ridge, the transition between the active and non-active sections of the optical modulator of the present invention may be formed with a step-like profile using an anisotropic mask and etching technique, a grinding technique, or other methods known to those skilled in the art.

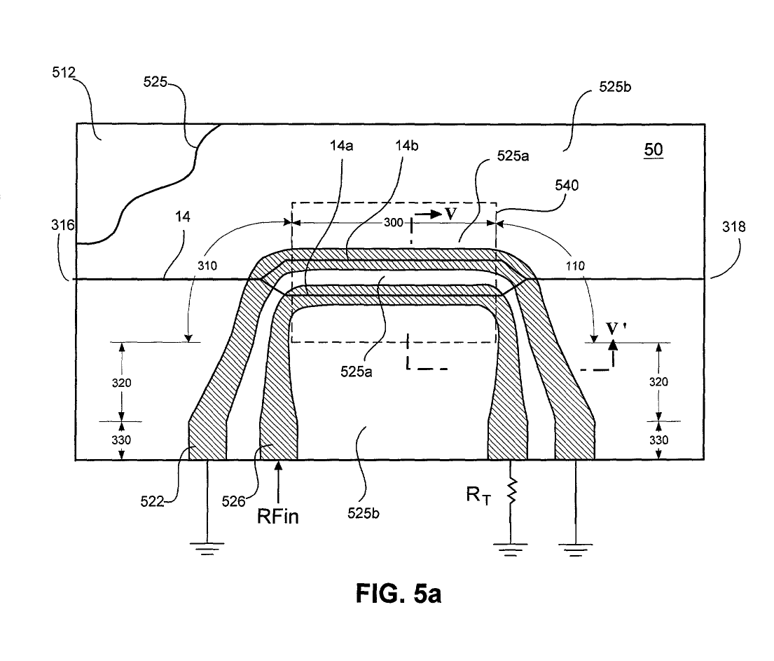

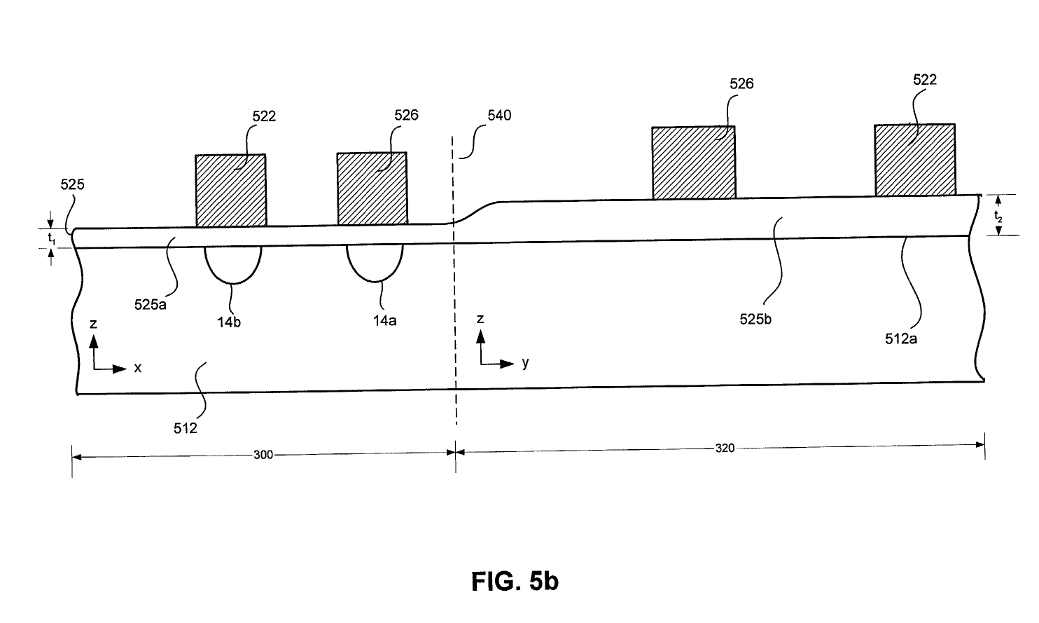

The buffer layer of the present invention also may substantially prevent a guided mode of a coplanar strip (CPS) waveguide structure from coupling with spurious modes of an underlying electrooptic substrate. FIGS. 5a and 5b show an optical modulator device 50 in accordance with a third exemplary embodiment of the present invention. Unlike the CPW modulators described above, optical modulator device 50 uses a CPS waveguide structure overlying a buffer layer having varied thickness. In FIGS. 5a and 5b, elements with the same numbers as in FIG. 3a to 4b are described above. As shown in FIG. 5a, a CPS waveguide having only one ground electrode 522 adjacent an active conductor (RF or “hot” electrode) 526 overlies a z-cut LiNbO₃ substrate with an intervening buffer layer 525. Ground electrode 522 and active conductor 526 respectively overlie optical waveguide arms 14b and 14a formed in the LiNbO₃ substrate. Of course, instead of z-cut LiNbO₃ substrates other types of electrooptic substrates and/or crystal cuts may be used consistent with the present invention. Within outlined area 540, a portion of the buffer layer 525 is thinned compared to the portion of buffer layer 525 outside area 540. In particular, buffer layer portion 525a formed within area 540 is thinner than buffer layer portion 525b formed outside of area 540.

As shown in FIG. 5b, ground electrode 522 and active conductor 526 overlie buffer layer portion 525b in non-active modulator section 320. Near the active section 300, buffer layer 525 tapers to form a thinner buffer layer portion 525a that underlies electrodes 522 and 526 in the active section 300. The tapered profile between the active and non-active device sections may be achieved by processes described above or other processes known in the art. Instead of a taper between thinner and thicker portions of buffer layer 525, the transition may alternatively be formed using one of the stepped profiles described above. Moreover, while a single CPW is shown in FIGS. 5a and 5b, it is to be understood that a plurality of CPWs may be used on one MZI. For example, each waveguide arm 14a, 14b may have an overlying separately controlled CPW, or a CPW alternatively may be provided on a single channel optical waveguide instead of on an MZI.

While the exemplary embodiments above describe MZI intensity modulators, it is to be understood that the buffer layer structure of the present invention may alternatively be used to the same effect with another modulator type, such as a phase modulator having a single optical channel, or a resonant optical modulator with either a single optical channel or MZI waveguide structure. The buffer layer of the present invention also may be used within a plurality of optical modulator devices cascaded on a common electrooptic substrate, for example.

While “squared” electrodes are shown in the depicted exemplary embodiments, it is to be understood that the device of the present invention may alternatively be used with other electrode profiles known to those skilled in the art, such as electrode profiles that include angled walls or ridges, for example.

The present invention also may be applied to any electrooptic material system capable of changing its optical characteristics under the influence of an electric field where undesirable mode coupling potentially exists. While the embodiments described in detail above primarily describe modulators using z-cut uniaxial crystal arrangements, the invention can also be used with x- or y-cut uniaxial crystal material by appropriately positioning the CPW electrodes.

The device of the present invention may operate more efficiently and at higher speeds than conventional devices because the effects of coupling to spurious higher-order modes and electrode losses are significantly avoided by the instant invention's forming of a thicker buffer layer only over non-active sections of the modulator. Thus, the operating frequency range is not significantly affected by electrode loss effects that otherwise would limit device performance, as in the prior art arrangements.

As should be clear from the embodiments described above, the present invention presents a modulation device useful for high-speed, low loss modulation of broadband optical data in optical circuits and/or fiber optic communication systems.

It will be apparent to those skilled in the art that various modifications and variations can be made in the optical modulator of the present invention without departing from the scope or spirit of the invention. Other embodiments of the invention will be apparent to those skilled in the art from consideration of the specification and practice of the invention disclosed herein. It is intended that the specification and examples be considered as exemplary only, and that the present invention cover the modification and variations of the invention provided they come within a true scope and spirit of the invention being indicated by the following claims and their equivalents.

What is claimed is:

1. An optical modulator comprising:
a substrate having an electrooptic effect;
an optical waveguide formed in the substrate;
a buffer layer formed on an upper surface of the substrate;
an RF electrode formed on the buffer layer; and
at least one ground electrode associated with the RF electrode formed on the buffer layer and situated on at least one side of the RF electrode, wherein the RF electrode cooperates with the at least one ground electrode to provide an electromagnetic field that overlaps with an optical signal in an active portion of the optical waveguide, and the buffer layer is thinner over a first portion of the substrate in an area including the active portion of the optical waveguide than over a second portion of the substrate.

2. The optical modulator of claim 1, wherein a portion of the RF electrode and the at least one ground electrode overlie the second portion of the substrate.

3. The optical modulator of claim 1, wherein the buffer layer further comprises a transitional portion having a tapered shape over an area of the substrate that borders the first and second portions of the substrate.

4. The optical modulator of claim 1, wherein the buffer layer further comprises a transitional portion having a step shape over an area of the substrate that borders the first and second portions of the substrate.

5. The optical modulator of claim 4, wherein the substrate further comprises a ridge.

6. The optical modulator of claim 4, wherein the buffer layer further comprises a substantially planar upper surface.

7. The optical modulator of claim 1, wherein the optical waveguide comprises a first section for launching a laser light to be modulated, a first junction splitting the first section into first and second arm sections, a second junction joining the first and second arm sections, and a second section extending from the second junction for outputting a modulated form of the laser light.

8. The optical modulator of claim 1, wherein the substrate is z-cut LiNbO₃ crystal, and the optical waveguide directly underlies one of the RF electrode and the at least one ground electrode.

9. The optical modulator of claim 1, wherein the substrate is x-cut LiNbO₃ crystal, and the optical waveguide is formed between the RF electrode and the at least one ground electrode.

10. The optical modulator of claim 1, wherein the optical modulator is one of a plurality of modulator devices integrated on a common substrate.

11. The optical modulator of claim 1, wherein a penetration of the electromagnetic field into the substrate is to a lesser extent in the second portion of the substrate than in the first portion of the substrate.

12. The optical modulator of claim 1, wherein the buffer layer has a lower dielectric constant than the dielectric constant of the substrate.

13. The optical modulator of claim 1, wherein the at least one ground electrode comprises two ground electrodes, one situated on either side of the RF electrode, respectively, to form a coplanar waveguide (CPW).

14. The optical modulator of claim 1, wherein the at least one ground electrode comprises a single electrode situated on one side of the RF electrode to form a coplanar strip (CPS) waveguide.
